(19) United States
(12) Patent Application Publication
(10) Pub. No.: US 2015/0290570 A1
(43) Pub. Date: Oct. 15, 2015

(54) HEATABLE FILTER

(71) Applicant: Eichenauer Heizelemente GmbH & Co. KG, Hatzenbuehl (DE)

(72) Inventor: Roland Starck, Bellheim (DE)

(21) Appl. No.: 14/685,872

(22) Filed: Apr. 14, 2015

(30) Foreign Application Priority Data
Apr. 14, 2014 (DE) 10 2014 105 298.6

(51) Int. Cl. B01D 35/18

(52) U.S. Cl. CPC B01D 35/18

(57) ABSTRACT

A heatable filter for a reducing agent includes a plastic housing that comprises a wall in which a heating resistor is disposed, and a filter insert which is attached to the wall.

### CROSS-REFERENCE TO RELATED APPLICATIONS

This application claims priority to German Patent Application No. 10 2014 105 298.6, filed Apr. 14, 2014, the entire contents of which are hereby incorporated by this reference.

### DESCRIPTION

### Background of the Invention

The invention is based on an electrically heatable filter for a reducing agent, said filter having the features of the preamble of claim 1, as is known for example from DE 10 2008 014 415 A1. Reducing agents are needed in exhaust gas purification catalysts. Typically, a urea solution is used as the reducing agent.

Heatable filters for the urea solution should be ready for operation as quickly as possible in freezing conditions, which means that they must thaw frozen urea solution rapidly, so that the filter can supply the urea solution to an exhaust gas purification catalyst. Such filters should also be easy to install and have the longest possible service life.

An object of the present invention is to provide an electrically heatable filter for urea solution that satisfies the aforementioned requirements more effectively.

### SUMMARY OF THE INVENTION

The object of the present invention is achieved with an electrically heatable filter for urea solution having the features listed in claim 1. Advantageous refinements of the invention are the subject matter of dependent claims.

The heating resistor is preferably cut out of a metal sheet. The metal sheet is most preferably a corrosion-resistant steel sheet.

A filter according to the invention for a reducing agent such as urea solution has a wall in which a heating resistor is arranged, and a filter insert that is attached to the wall. The filter insert may lie flat against the wall without attachment, or it may be secured thereto, for example by adhesion or welding. The wall forms a ring, or part of a ring, e.g. the wall may be U-shaped or C-shaped. The wall may be corrugated or continuously curved. It is also possible for the curved wall to be made up of segments, wherein adjacent segments enclose obtuse angles.

The filter insert may be surrounded by the wall. Alternatively, it is also possible for the filter insert to be secured to the outside of the wall. The wall is preferably a ring wall. However, the wall may also be U-shaped or C-shaped, not entirely encircling the filter insert, particularly if the filter is arranged on the wall of a tank such that the tank wall fills a gap in the wall of the filter. The heating resistor is preferably cut out of a metal sheet. The metal sheet is most preferably a corrosion-resistant steel sheet.

If the wall has a corrugated shape, for example a zigzag corrugation, the ring wall is particularly well adapted to compensate for changes in volume associated with freezing and thawing of urea solution because the wall can easily deform and expand as necessary. The corrugated shape of the ring wall also ensures that there is sufficient space for urea solution between the filter insert and the wall, and urea solution may be thawed quickly due to the enlarged surface area of the wall. The heating resistor, which is enclosed in liquid-tight manner in the wall thus ensures that ice present between the filter insert and the wall can be thawed very rapidly. The filter is thus ready for operation and is able to deliver liquid urea solution after a short time even in freezing conditions.

An embodiment of the invention provides that the heating resistor consists of strips arranged side-by-side, the ends of which are connected to each other.

The heating resistor is preferably connected in series to a polymer PTC element (PPTC), which protects the filter heater from overheating. However, other types of temperature limiting devices or fuses, such as bimetallic switches, are also conceivable. The temperature element is most preferably disposed in a chamber in the wall. If the PPTC element is disposed in a hollow chamber, that is to say a chamber containing air, it is thermally decoupled from the wall and thus also from the heating resistor. This allows the PPTC element to serve as a safety device against overheating, which is only actuated in rare emergencies and never in normal operation. A chamber that is filled with potting compound is not hollow, and thereby causes significantly greater thermal coupling between the PPTC element and the wall.

An advantageous embodiment therefore provides that plugged connectors for the power supply to the heating resistor extend in airtight manner through the chamber wall into a connector housing.

The filter may be arranged upright in a tank. If a sump of dirt particles forms in a tank, with conventional filters this typically results in the rapid failure of the filter due to clogging. With a filter according to the invention, this does not happen. Due to its upright arrangement, at least a part of the axial length of the filter may protrude above any sump that may form and thus continue to perform its intended task.

A further advantage of a filter according to the invention is that the sensitive filter insert is protected by the wall from damage inflicted by urea ice, which might knock against the filter with considerable force when a motor vehicle is in motion.

An advantageous refinement of the invention provides that the filter insert includes an inner space between a radially inner filter sheet and a radially outer filter sheet. Urea solution is able to flow into the inner space both radially inwardly through a clearance between the wall and the radially outer filter sheet and radially outwardly through the radially inner filter sheet. In this way a larger filter surface area is created than in conventional filters for the same space requirement. Consequently, functional failure due to clogging is only caused by significantly larger quantities of dirt than is the case with conventional filters.

A further advantageous refinement of the invention provides that the filter insert and/or that plastic housing have protrusions that form a thermal bridge between the plastic housing and the filter insert. These protrusions are preferably elongated and extend parallel to the corrugations of the corrugated wall, in the manner of ribs or webs. In particular, crests of the corrugated wall conformed as protrusions may lie flush with the filter insert.

The filter insert may have protrusions that lie flush with the corrugated wall, or the corrugated wall may have corrugation crests that lie flush against the filter insert. In this context, the corrugation crests may be extended by ribs or webs on the side thereof facing toward the filter insert (i.e., perpendicularly to the wall). Protrusions of the filter insert and the wall preferably mesh with each other, in the manner of a tongue and groove joint, for example.

### BRIEF DESCRIPTION OF THE DRAWINGS

Further details and advantages of the invention will be explained with an illustrative embodiment thereof and a with reference to the accompanying drawings. In the drawings:

FIG. 1 shows an embodiment of a filter heater for urea solution with a filter insert;

FIG. 2 shows the filter heater of FIG. 1 without the housing or filter insert;

FIG. 3 is a cross-sectional view of the filter heater; and

FIG. 4 is a view of a detail of FIG. 1.

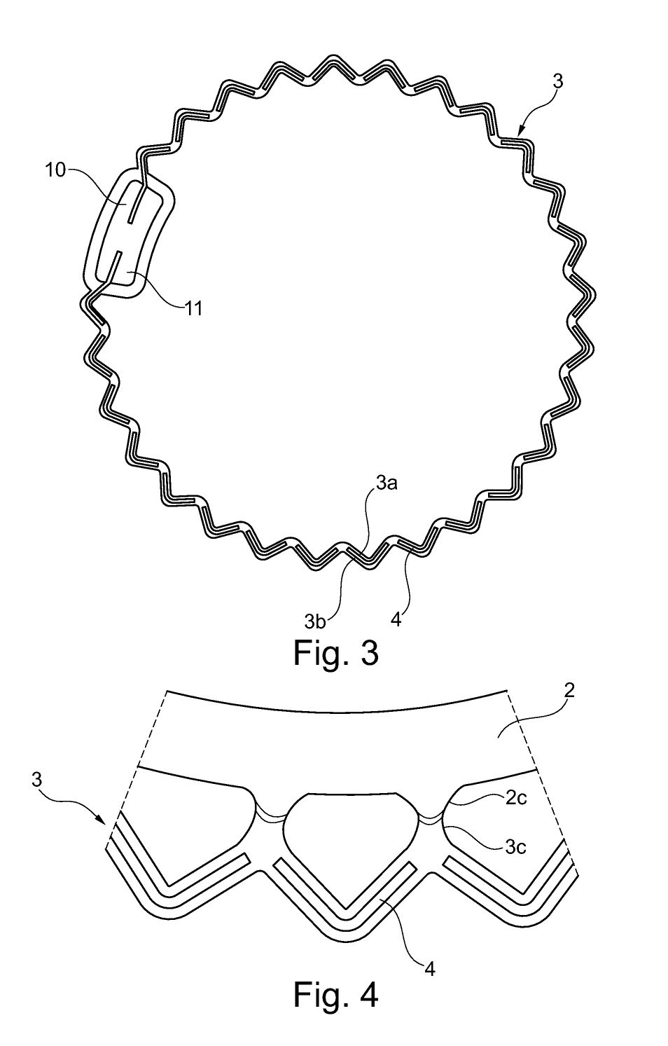

### DETAILED DESCRIPTION OF THE PREFERRED EMBODIMENTS

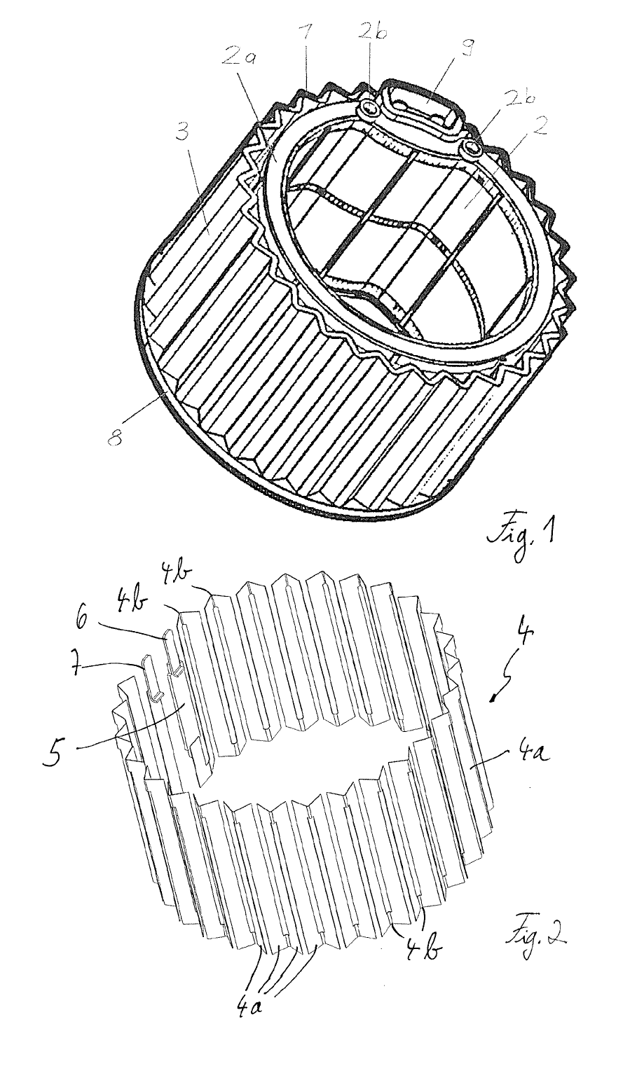

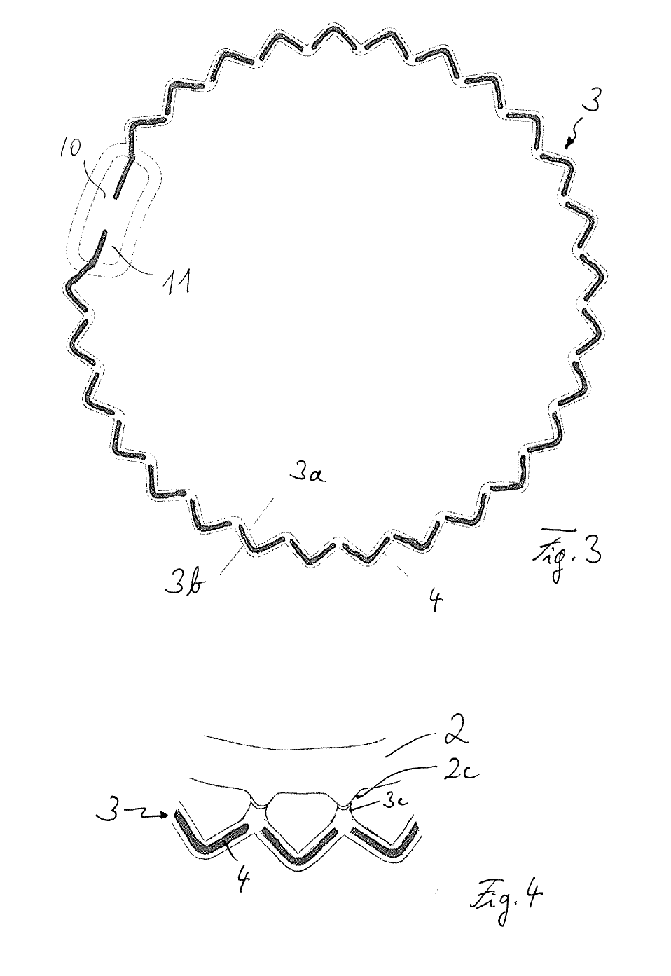

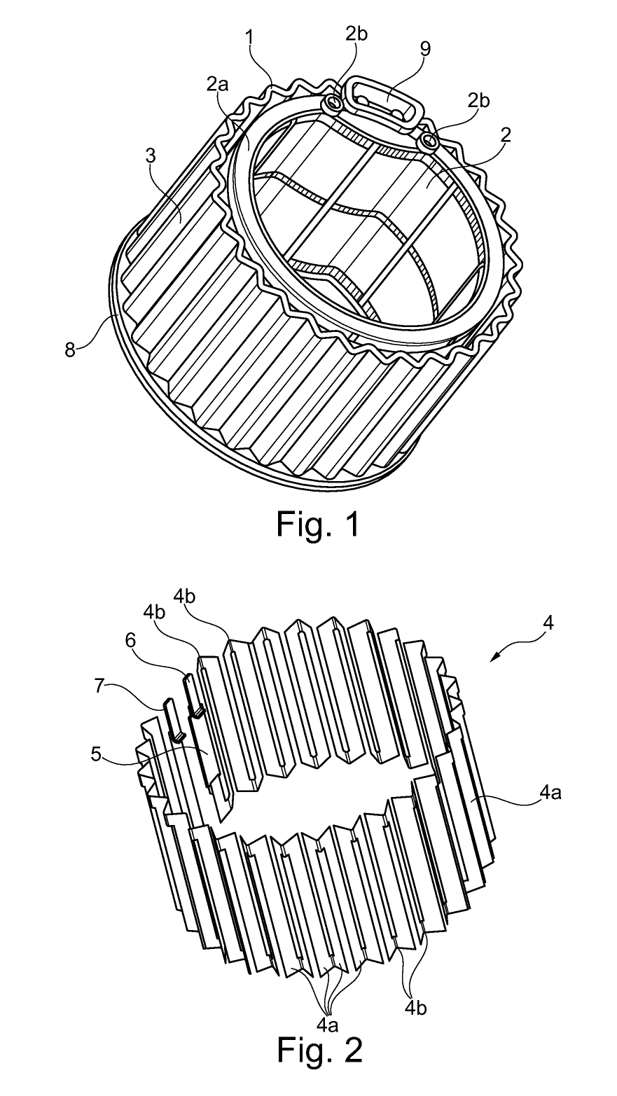

FIG. 1 shows a filter for urea solution with a filter heater 1 and a filter insert 2. Filter heater 1 has a plastic housing that is open at both axial ends and comprises a ring wall 3 with a zigzag corrugated shape that surrounds filter insert 2. A heating resistor 4 is enclosed in fluid-tight manner inside ring wall 3, and is convoluted in a zigzag shape conforming to that of ring wall 3. FIG. 2 shows the filter heater 1 of FIG. 1 but without the plastic housing and filter insert. FIG. 3 is a cross sectional view of filter heater 1 without the filter insert.

Filter insert 2 has a radially inner filter sheet and a radially outer filter sheet, which are secured to an upper plastic ring 2a and a lower plastic ring (not shown). A frontal face of filter insert 2, for example upper ring 2a, comprises one or more ports 2b for drawing off filtered urea solution. Urea solution may enter the filter insert through both the radially outer and the radially inner filter sheets. Urea solution may thus either flow radially inwardly through the clearance between ring wall 3 and the radially outer filter sheet or radially outwardly through the radially inner filter sheet. The filter thus has a very large filter surface, which is highly advantageous.

The filter may be disposed upright in a tank. Dirt particles are deposited at the bottom of a tank, and can form a sump there. With an upright arrangement, it is practically impossible for such a sump to cause the premature failure of the filter, since the topmost section of the filter is typically at a higher level than any sump that forms.

Filter insert 2 may lie flush against an axial end of ring wall 3. However, filter insert 2 may also be disposed completely in the inner space enclosed by ring wall 3. Filter insert 2 may be secured to ring wall 3, for example by clipping filter insert 2 into the ring wall. In another possible variant, the filter insert has a rim that lies flush against ring wall 3 and is welded thereto.

Heating resistor 4 is cut out of a sheet of metal, for example steel. The sheet may be from 0.2 to 0.4 mm thick, for example. Heating resistor 4 consists of a number of strips 4a arranged side by side, each of which is connected to the respective adjacent strip 4a at one end. Strips 4a are preferably arranged parallel to each other and connected to each adjacent strip 4a via a web 4b at one end. Heating resistor 4 may be produced by cutting slots in a sheet metal strip perpendicularly to its longitudinal direction and beginning from alternating longitudinal edges thereof. Heating resistor 4 is bent in a zigzag shape by bending webs 4b alternatingly, for example by bending all webs 4b at the top end of strips 4a radially inwards, and all webs at the bottom end of strips 4a radially outwards. Adjacent strips 4a of heating resistor 4 are then twisted relative to one another, about a geometric axis extending along the longitudinal direction of the strips. The sectional plane of FIG. 3 extends through webs 4b of the heating resistor 4 shown in FIG. 2.

Heating resistor 4 may be surrounded by a plastic cladding to provide improved protection against corrosive liquid. The plastic cladding then forms a first protective layer, and the plastic housing forms a second protective layer. The plastic cladding may be made from the same or a different material than the plastic housing.

One end of heating resistor 4 is connected in series to a polymer PTC element 5 (PPTC). PPTC 5 protects filter heater 1 from overheating. If the temperature of PPTC 5 exceeds a threshold temperature, its electrical resistance increases sharply, so that the heat output is reduced almost to zero. PPTC 5 is connected to one end of a strip of heating resistor 4. This strip is shorter than the strip beside it and may also be of different width. The thermal coupling of PPTC 5 with heating resistor 4 can be adjusted via the width of this strip and the size of its connecting area with PPTC 5. For example, the section of heating resistor 4 that is adjacent to PPTC 5 may be of reduced width. In this way, the thermal coupling between PPTC 5 and heating resistor 4 is reduced. PPTC 5 functions as a safety mechanism to protect against overheating and in this case is actuated more slowly, so that the PPTC is not actuated when the filter heater is operating normally, but only functions in extreme cases. PPTC 5 is connected to a connector pin 6, which protrudes from the plastic housing. A second connector pin 7 is attached to a strip at the other end of heating resistor 4.

3

The plastic housing of the filter heater may be manufactured from polyethylene, for example. Ring wall 3 is a double-walled ring wall with an inner ring wall 3a and an outer ring wall 3b. Inner ring wall 3a and outer ring wall 3b are corrugated in a zigzag course parallel to each other, and thus consist of a series of peaks and valleys extending transversely to the circumferential direction of ring wall 3. A peak on the outside thus forms a valley on the inside, and vice versa. The radial distance between the peaks and the valleys is thus equal to a multiple of the wall thickness.

Heating resistor 4 is enclosed in liquid-tight manner between inner ring wall 3a and outer ring wall 3b. Inner ring wall 3a and outer ring wall 3b each have a thickness preferably not exceeding 1.5 mm, inner ring wall 3a and outer ring wall 3b may have a thickness from 0.5 mm to 1.0 mm, for example.

3

Ring wall 3 may form a plug housing 9 for connecting heating resistor 4 to a power source. Plug housing 9 may comprise guide elements, for example fillets or grooves, for a mating plug connector. Ring wall 3 may form a chamber 10 in which the two ends of the heating resistor 4 and the PPTC 5 are disposed. The hollow, air-filled chamber may be an extension of plug housing 9 with the same cross section as is the case in the embodiment shown. Chamber 10 and plug housing 9 have a partition wall 11, through which connectors 6, 7 are passed in airtight manner.

In order to improve the thermal coupling of filter insert 2 with filter heater 1, the filter insert 2 and/or the plastic housing of filter heater 1 may have protrusions 2c, 3c that form thermal bridges between ring wall 3 and filter insert 2. Protrusions 2c, 3c are elongated and extend in the axial direction of ring wall 3. Protrusions 2c of filter insert 2 and protrusions 3c of ring wall 3 preferably mesh with each other. In this way, the surface area of the contact between ring wall 3 and filter insert 2 is advantageously increased, thereby improving the thermal contact.

Each radially inwardly facing corrugation crest 3c of zigzag corrugated ring wall 3 may lie flush against filter insert 2, particularly against a protrusion 2c of filter insert 2, for example. Corrugation crest 3c of ring wall 3 or the filter insert 2 or protrusion 2c of the filter insert preferably forms groove into which protrusion 2c of filter insert 2 or protrusion 3c of the wall projects.

### LIST OF REFERENCE NUMERALS

1 Filter heater
2 Filter insert
2a Ring
2b Port
2c Protrusion
3 Ring wall
3a Inner ring wall
3b Outer ring wall
3c Protrusion of the ring wall
4 Heating resistor
4a Strip
4b Web
5 PPTC
6 First plug pin
7 Second plug pin
8 Ring
9 Plug housing
10 Chamber
11 Partition wall

1. An electrically heatable filter for a reducing agent, the filter comprising:
a plastic housing that comprises a wall in which a heating resistor is disposed;
a filter insert mounted on the wall; and
wherein the wall is corrugated.

2. The filter according to claim 1, wherein the wall is a ring wall.

3. The filter according to claim 1, wherein the filter insert is surrounded by the wall.

4. The filter according to claim 1, wherein the filter insert comprises an inner space between a radially inner filter sheet and a radially outer filter sheet, into which inner space urea solution is able to flow both radially inwardly and into which urea solution is able to flow radially outwardly through the radially inner filter sheet.

5. The filter according to claim 1, wherein the filter insert comprises at least one port on an axial frontal face thereof for drawing off filtered urea solution.

6. The filter according to claim 5, wherein the filter insert comprises two rings between which the radially inner filter sheet and the radially outer filter sheet are held in place.

7. The filter according to claim 1, wherein the filter insert has a rim that lies flush against one axial end of the wall.

8. The filter according to claim 1, wherein the filter insert is joined to the plastic housing by welding.

9. The filter according to claim 1, wherein the plastic housing leaves the enclosed space open at both axial frontal faces thereof.

10. The filter according to claim 1, wherein the heating resistor is cut out of a metal sheet, particularly a corrosion-resistant steel sheet, and consists of a series of strips arranged side by side.

11. The filter according to claim 1, wherein the heating resistor is corrugated like the ring wall and bent in a zigzag shape.

12. The filter according to claim 1, including plug contacts that protrude from the frontal face of the wall for connecting the heating resistor.

13. The filter according to claim 1, wherein the plastic housing and/or the filter insert have protrusions that form a thermal bridge between the plastic housing and the filter insert.

14. The filter according to claim 1, wherein the heating resistor is surrounded by a plastic cladding inside the plastic housing.

15. An electrically heatable filter for a reducing agent, the filter comprising:
a plastic housing that comprises a wall in which a heating resistor is disposed;
a filter insert attached to the wall; and
wherein the wall has a hollow chamber in which a PPTC is disposed.

16. The electrically heatable filter according to claim 15, wherein the PPTC is connected in series to the heating resistor, the heating resistor being cut out of a metal sheet and consists of a row of strips arranged side-by-side, wherein a section of the heating resistor that is adjacent to the PPTC is of reduced width.

17. An electrically heatable filter for a reducing agent, the filter comprising:
a plastic housing that comprises a wall in which a heating resistor is disposed;
a filter insert attached to the wall; and
wherein the filter insert includes an inner space between a radially inner filter sheet and a radially outer filter sheet, into which inner space urea solution is able to flow radially inwardly and into which urea solution is able to flow radially outwardly through the radially inner filter sheet.
